(19) United States
(12) Patent Application Publication
(10) Pub. No.: US 2026/0148179 A1
(43) Pub. Date: May 28, 2026

(54) PREVENTING DATABASE CORRUPTION FROM ADVANCED SHIPPING NOTICES

(71) Applicant: Target Brands, Inc., Minneapolis, MN (US)

(72) Inventors: Prasoon Gokulan, Bengaluru (IN); Lakshmi Prasanna Veeramasu, Bengaluru (IN); Beaula Bency, Bengaluru (IN); Mary E. Jenniges, Annandale, MN (US); Dawn M. Oppelt, Lake Elmo, MN (US); Danielle Grieme, Lake Elmo, MN (US)

(21) Appl. No.: 18/962,623

(22) Filed: Nov. 27, 2024

(51) Int. Cl. G06Q 10/0833

(52) U.S. Cl. CPC G06Q 10/0833

(57) ABSTRACT

A method includes receiving an advanced shipping notice from a shipper, parsing a shipping date from the advanced shipping notice, comparing the shipping date to an arrival date stored in an entry for a container, and treating the advanced shipping notice as an updated advanced shipping notice instead of an original advanced shipping notice when the shipping date is before the arrival date or less than a selected number of days after the arrival date.

### BACKGROUND

Modern shipping relies on a large number of electronic documents to handle payment for the products and freight costs, transfer of title between entities involved in the shipment and transfer of bills of lading that specify who is to receive the shipped products. Advanced Shipping Notices are one type of shipping document sent by a shipper (consignor) to a receiver (consignee) to provide information about a shipment that has been placed on a vessel.

The discussion above is merely provided for general background information and is not intended to be used as an aid in determining the scope of the claimed subject matter. The claimed subject matter is not limited to implementations that solve any or all disadvantages noted in the background.

### SUMMARY

A method includes receiving an advanced shipping notice from a shipper, parsing a shipping date from the advanced shipping notice, comparing the shipping date to an arrival date stored in an entry for a container, and treating the advanced shipping notice as an updated advanced shipping notice instead of an original advanced shipping notice when the shipping date is before the arrival date or less than a selected number of days after the arrival date. In accordance with a further embodiment, a system includes an advanced shipping notice receiving system that receives advanced shipping notices and an advance shipping notice logic system that performs steps. The steps include comparing a shipping date for a container in a received advance shipping notice to an arrival date in an existing record for the container. When the shipping date is after the arrival date by a selected number of days, processing the advanced shipping notice as an initial advanced shipping notice for a shipment. When the shipping date is before the arrival date or less than the selected number of days after the arrival date the arrival, processing the advanced shipping notice as an update to an initial advanced shipping notice.

In accordance with a still further embodiment, a method in a computing system susceptible to data corruption includes receiving a data packet and using a date field to determine that the data packet contains updated data instead of initial data. Data in the data packet is then added to a database such that the database is not corrupted with double counting of items in the data packet.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of participants involved in a shipping system.

FIG. 2 is flow diagram of steps involved in conveying items from a shipper to a receiver.

FIG. 3 is an example of an initial advanced shipping notice.

FIG. 4 is an example of an updated advanced shipping notice.

FIG. 5 is a flow diagram of a method of efficiently determining if an advanced shipping notice is an initial notice or an updated notice.

FIG. 6 is flow diagram of a method of processing an initial advanced shipping notice.

FIG. 7 is a flow diagram of a method of processing an updated advanced shipping notice.

FIG. 8 is a flow diagram of a method of posting markups.

FIG. 9 is a flow diagram of a method performed upon receiving a carrier invoice.

FIG. 10 is a block diagram of a system used to perform the various methods.

FIG. 11 is a block diagram of a computing device used to perform the various methods.

### DETAILED DESCRIPTION

The information in advanced shipping notices is sometimes incorrect resulting in incorrect data being entered into databases. Shippers will sometimes send further advanced shipping notices to correct earlier advanced shipping notices. However, it can be unclear whether an advanced shipping notice is an initial notice or an update to a previous notice and it can be unclear what information is being corrected. Because of this, items on the vessel are often double counted while the vessel is in transit resulting in significant database corruption. For example, when a second advanced shipping notice is received that identifies a same vessel and purchase order as a previous advanced shipping notice but uses a different bill of lading identifier, it is unclear whether the items listed for the new bill of lading identifier are in addition to the items reported in the earlier advanced shipping notice or are the same items placed under a corrected bill of lading identifier.

The embodiments described below provide an efficient means for distinguishing initial advanced shipping notices from updated advanced shipping notices and for accepting correct information in an advanced shipping notice even when the advanced shipping notice contains other information that may be incorrect. In so doing, the embodiments improve the technology of shipping tracking by avoiding double counting of items while providing a system that can automatically overcome erroneous information in one or more advanced shipping notices.

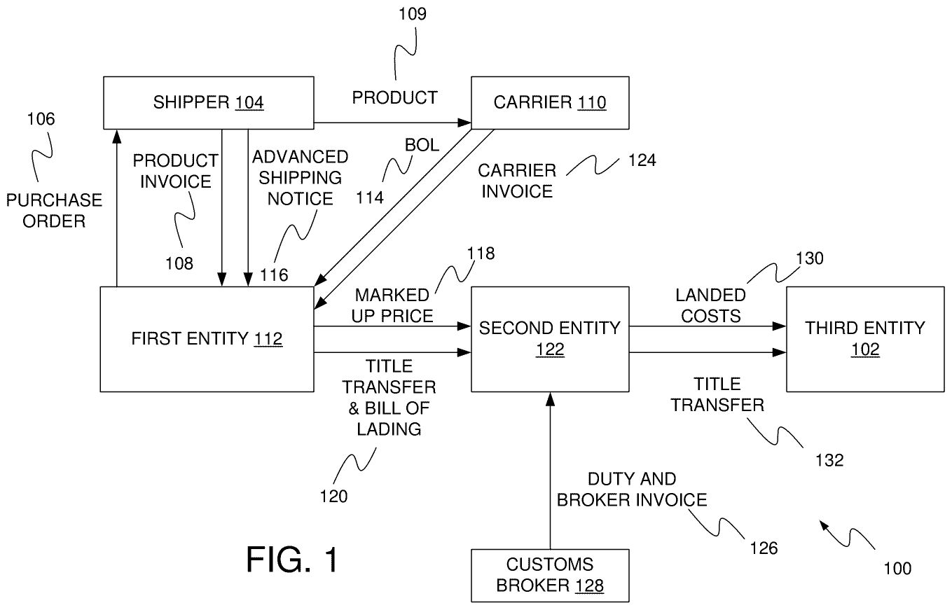

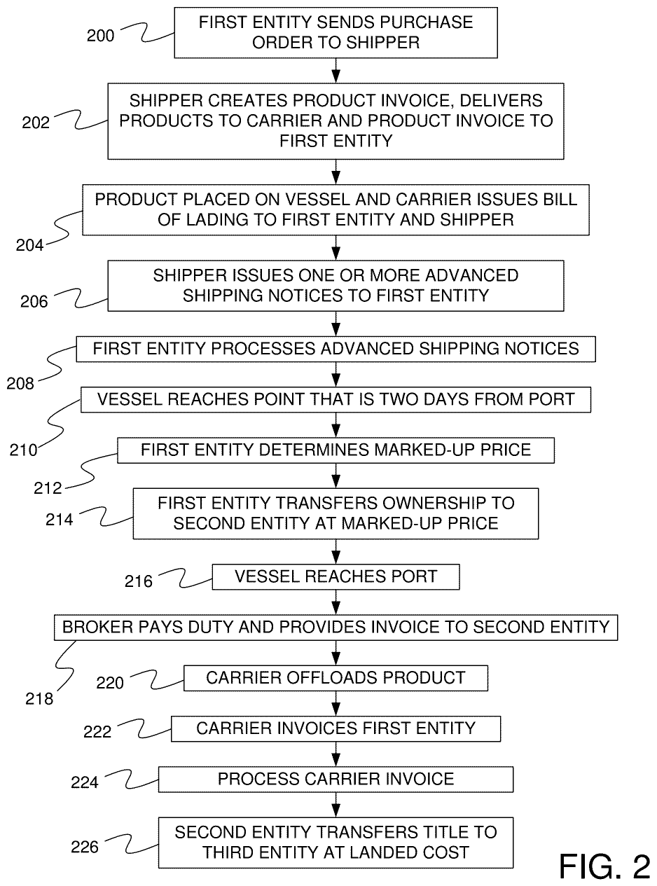

FIG. 1 provides a block diagram of participants involved in a shipping system and the conveyance of documents and titles between these participants as part of shipping products. FIG. 2 provides a flow diagram of steps involved in conveying items from a shipper to a receiver including steps required for payment of invoices and transfers of title.

In FIG. 1, a first entity 112, a second entity 122 and a third entity 102 are shown as participants in the shipment. In accordance with one embodiment, first entity 112, second entity 122 and third entity 102 are separate business entities within a larger business organization. For example, first entity 112 can be a corporation incorporated in a first country that takes ownership of the shipment once it is loaded on a vessel, second entity 122 can be a corporation incorporated in a second country that takes title from the first entity during transit of the vessel and marks up the price of the product before selling the product to third entity 102, and third entity 102 can be a corporation incorporated in a high tax country. Using this structure, a portion of the income received from selling the product to consumers is attributed to second entity 122 instead of third entity 102.

In step 200 of FIG. 2, first entity 112 of system 100 provides a purchase order 106 to a shipper 104. At step 202, shipper 104 creates a product invoice 108 and delivers products 109 to a carrier 110. In addition, shipper 104 provides the product invoice to first entity 112. Product invoice 108 provides a list of items that the shipper is shipping together with a price for those items.

At step 204, products 109 are placed on a vessel by carrier 110 and carrier 110 issues a bill of lading 114 to first entity 112. The bill of lading includes a bill of lading identifier and a list of the items loaded on to the vessel. The bill of lading also identifies the carrier, and the receiver and the destination for the products. The receiver can be listed as either first entity 112 or a third entity 102.

At step 206, shipper 104 issues one or more advanced shipping notices 116 to first entity 112. Each advanced shipping notice is an attempt to describe what is being shipped on a vessel with respect to purchase order 106.

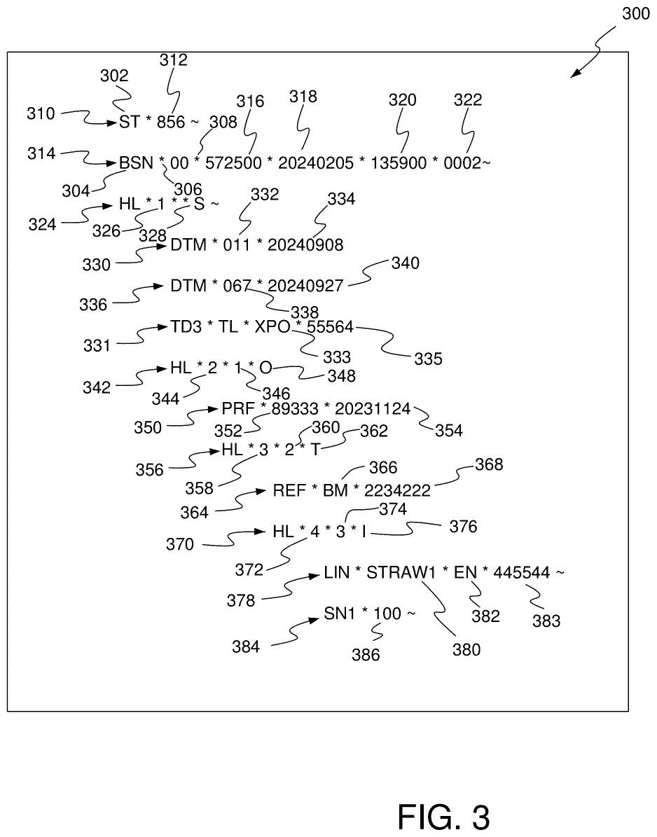

FIG. 3 provides an example of an advanced shipping notice 300 consisting of a set of line entries with each line entry headed by a code, such as code 302 and code 304 that indicates the content of the respective line. Each code has an associated set of fields that are separated from each other by delimiter stars, such as stars 306 and 308.

Advanced shipping notice 300 has a hierarchical structure beginning with a top level associated with the notice itself, a next level associated with shipments, a further level associated with purchase orders carried in a shipment, a next level associated with containers on a shipment, and a last level associated with items in a container.

In advanced shipping notice 300, first line 310 has code “ST”, which that indicates that this line contains information about the document itself. In particular, line 310 includes field 312 that provides a number indicating that this is an advanced shipping notice. Line 314 includes code “BSN” indicating that this is a beginning segment for a ship notice and providing a unique shipping notice identification field 316, date and time fields 318 and 320 indicating the date and time that this notice was issued and a hierarchal structure code 322 indicating the structure of the hierarchy found within the advanced shipping notice.

Line 324 includes the code “HL” indicating that this line provides information about a hierarchal level in the structure of the notice. Line 324 also includes a unique identifier 326 for this hierarchical level and a level type 328, which is set to “S” to indicate that this level is for a shipment. Any lines between line 324 and another hierarchal level with a level type set to “S” are considered to be describing the contents of the same shipment. Line 330 includes the code “DTM” indicating that this line is a date/time reference with a type 332 of “011” indicating that this is a “shipped” date and a date 334. Line 336 is also a date/time reference line and includes a type 338 “067” indicating that this is a “scheduled delivery” date and a date 340. Line 331 includes the code TD3 indicating that this line provides carrier equipment details. In particular, line 331 identifies a container that holds the items being shipped using an initials field 333 and a number field 335.

Line 342 provides information for a second hierarchal level having a unique identifier 344 and a parent hierarchical level 346 set to the unique identifier of the level described in line 324. Level type 348 of line 342 is set to “O” indicating that this hierarchal level is for a purchase order. All lines from line 342 to another hierarchy level line with a level type of “O” or “S” are considered to be for a same purchase order.

Line 350 includes a code “PRF” indicating that the line is a purchase order reference that includes a purchase order number 352 and a purchase order date 354. Purchase order number 352 provides a unique identifier for the purchase order and date 354 provides a date for the purchase order. Line 356 designates the start of a third hierarchal level and includes a unique identifier 358 for the level, parent level identifier 360 which is the unique identifier for the level described in line 342, and a level type 362 of “T” indicating this level is for a tare. In this context, a “tare” is shipping container placed on the vessel. All lines from line 356 to another hierarchical level line having a level type of “T”, “O” or “S” are considered to be related to a same container.

Line 364 has the code “REF” indicating that this line provides reference information. Field 366 of line 364 contains the code “BM”, indicating that this reference information is for a bill of lading. Line 364 also includes a bill of lading number 368.

Line 370 designates the start of another hierarchical level and includes a unique identifier 372 for the level, and a parent level identifier 374, which is the unique identifier for the level described in line 356. Line 370 also includes a level type 376 of “I”, indicating that this level contains information about items. All lines between line 370 and a next hierarchical level line are considered to describe the same set of items.

Line 378 includes the code “LIN” indicating that this line includes item identification information. Line 378 includes alphanumeric characters 380 for differentiation of the items, system code 382 which designates an item coding system being used to identify the item, and item identifier 383, which identifies the item under the coding system.

Line 384 begins with the code “SN1” indicating that line 384 provides detailed information about the items. In particular, the number of items being shipped 386 in the container. Thus, line 378 identifies the items being shipped and line 384 indicates the number of those items being shipped.

Although only a single hierarchical level of each type is shown in FIG. 3, there may be multiple hierarchical levels of each type in and advance shipping notice. For example, there can be multiple hierarchical levels of type “I” within a hierarchical level of type “T” and multiple hierarchical levels of type “T” within a hierarchical level of type “O”. Thus, multiple items can be described that are within a same container and multiple containers can be associated with a single purchase order.

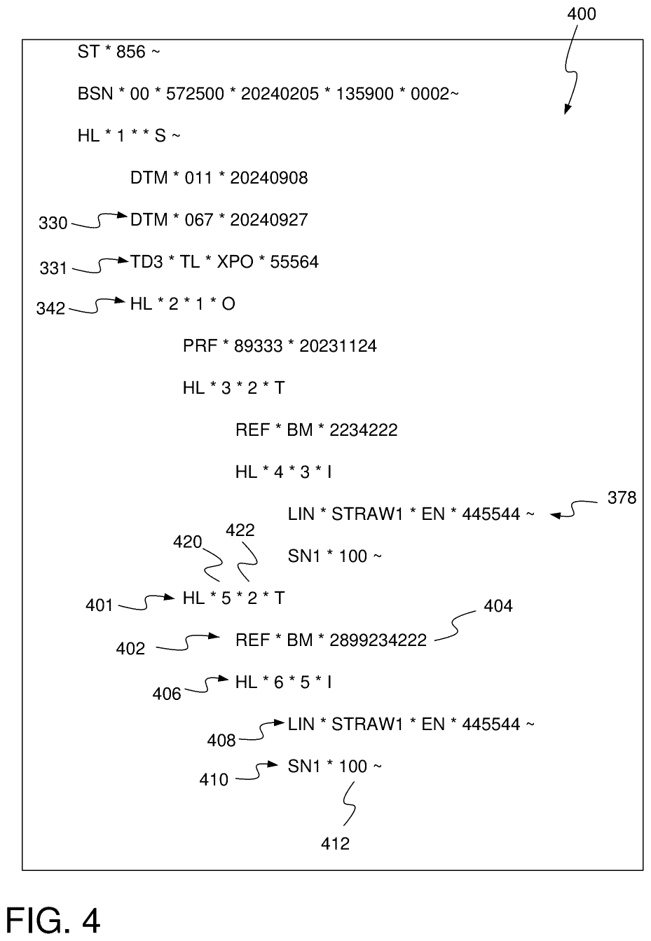

FIG. 4 provides an example of a second advanced shipping notice 400 sent by shipper 104 after advanced shipping notice 300. Advanced shipping notice 400 is identical to advanced shipping notice 300 with the addition of lines 401, 402, 406, 408 and 410. Line 401 includes a unique identifier 420 of “5” and a parent identifier 422 of “2”, thereby indicating that the hierarchical level started by line 401 is a second hierarchal level within the purchase order hierarchal level headed by line 342. Line 401 also indicates that the level has a type of “T’ indicating that it describes a container.

Line 402 within the hierarchical level is a reference line that provides a second bill of lading number 404.

Line 406 describes a hierarchical level within the hierarchical level of line 402. Specifically line 406 provides a new unique level identifier “6” and references the hierarchical level of line 401 as its parent level. Line 406 indicates that the hierarchical level has a level type of “I”, indicating that it is an item hierarchical level.

Line 408 is an item identification line that identifies the same type of items as found in line 378 and line 410 provides a count 412 of the number of items in the hierarchical level started by line 406.

Comparing FIGS. 3 and 4, it can be seen that it is not clear which of these documents is an initial document and which document is an updated document. In order to make this determination, one would have to access a database to see if any records have been stored for the shipment identified in “BSN” line 314. Further, it is not clear whether the additional bill of lading in advanced shipping notice 400 has been added by error and the parts are therefore being double counted.

Returning to FIG. 2, at step 208, first entity 112 processes the advanced shipping notices it receives in an efficient manner so as to quickly discern whether an advanced shipping notice is an initial advanced shipping notice or an updated advanced shipping notice and to determine whether the advanced shipping notice includes duplicative information or is a correction providing information that was lacking from an earlier advanced shipping notice.

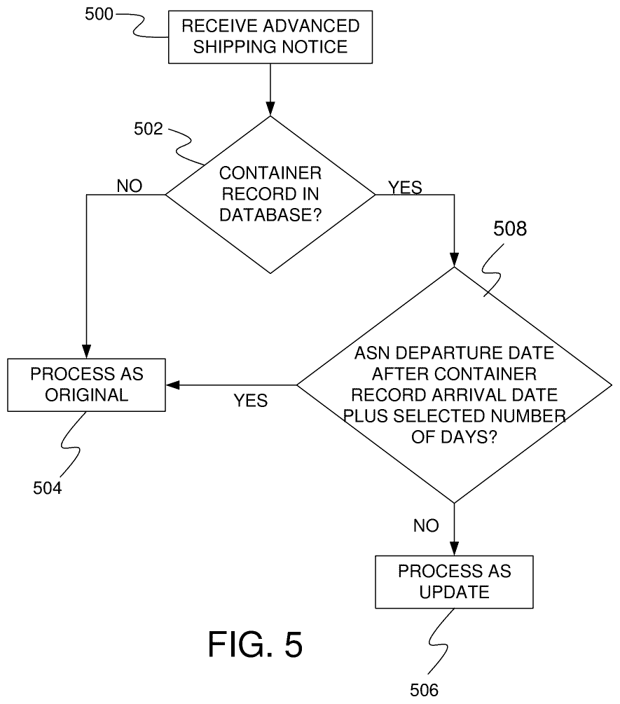

FIG. 5 provides a flow diagram of the initial processing performed by first entity 112. In step 500, an advanced shipping notice is received and at step 502, first entity 112 searches a database of container records for the container identified in line 331 of FIGS. 3 and 4. If no container record is found, the advanced sipping notice is processed as an original shipping notice.

If a container record is found for the container identified in line 331, first entity 112 examines the shipping date listed in line 330 of FIGS. 3 and 4 to determine if the shipping date is before an arrival date set in the database record for the container or is less than a selected number of days after the arrival date at step 508. In accordance with one embodiment, the selected number of days is fifty days. If the shipping date is before the arrival date or less than the selected number of days after the arrival date, the advanced shipping notice is considered to be an updated advanced shipping notice at step 506. If the shipping date is after the arrival date in the container's database record by more than the selected number of days, the advanced shipping notice is processed as an original advanced shipping notice at step 504. Thus, the method of FIG. 5 quickly determines whether to treat an advanced shipping notice as an original/initial advanced shipping notice at step 504 or to treat the notice as an updated advanced shipping notice at step 506.

It is desirable to maintain container records in the database to facilitate auditing of past shipments. However, because updated advanced shipping notices can be sent, maintaining container records can lead to data corruption. Specifically, when an advanced shipping notice is received that contains the same container identifiers as an existing container record, it would be simplest to assume that the advanced shipping notice is an updated advanced shipping notice. However, because containers are reused, it is possible that the advanced shipping notice is for a completely different shipment and is not an updated advanced shipping notice for the record in the database. If an advanced shipping notice is treated as an updated advanced shipping notice when it is actually an original advanced shipping notice, the records in the database become corrupted with bad data. By comparing the shipping date in the advanced shipping notice to the arrival date in the container record, this data corruption is avoided. Specifically, if the shipping date is more than the selected number of days after the arrival date, it is more likely that the advanced shipping notice is an original advanced shipping notice rather than an updated advanced shipping notice. For example, before a container can be reused it must be returned to the shipper's port, which typically takes fifty days. Thus, if it has been more than fifty days since the container arrived, it is likely that the container is being reused to send a new shipment. Thus, an advanced shipping notice with a shipping date that is more than fifty days after the arrival date is an original advanced shipping notice even though there is a container record for the container in the database.

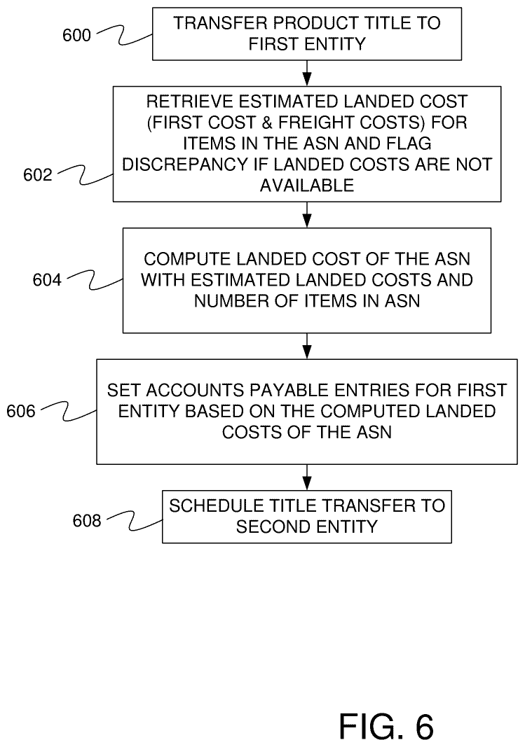

FIG. 6 provides a method for processing an advanced shipping notice as an initial advanced shipping notice in step 504. In step 600, title to the products in the advanced shipping notice is transferred to the first entity. Such title transfer can be performed by making an accounting entry in an accounting system as discussed further below. The number of products in the title transfer is set based on the number of items in the advanced shipping notice. In particular, within the purchase order level of the advanced shipping notice, the number of each uniquely identified item listed in the advanced shipping notice is used to set the title of those items to the first entity. Items sharing a same identifier but located in different container levels within the purchase order level are added together to obtain the total number of those items in the purchase order level.

At step 602, for each item type in the advanced shipping notice, the estimated landed cost details i. e the product cost(first cost) and freight charges are obtained from the purchase order. If the landed cost details are not available in the purchase order, a flag is sent to a user.

At step 604, the overall landing cost for an ASN is computed by multiplying the costs fetched for an item in step 602 by the number of items the advanced shipping notice indicates were shipped.

At step 606, accounts payable entries for first entity 112 are entered into an accounting system based on the landing costs computed in step 604. These accounts payable entries can be made on an item type-by-item type basis or on a purchase order basis. At step 608, a title transfer to second entity 122 is scheduled for a date that is two days before the scheduled delivery date found in line 336 of the advanced shipping notice.

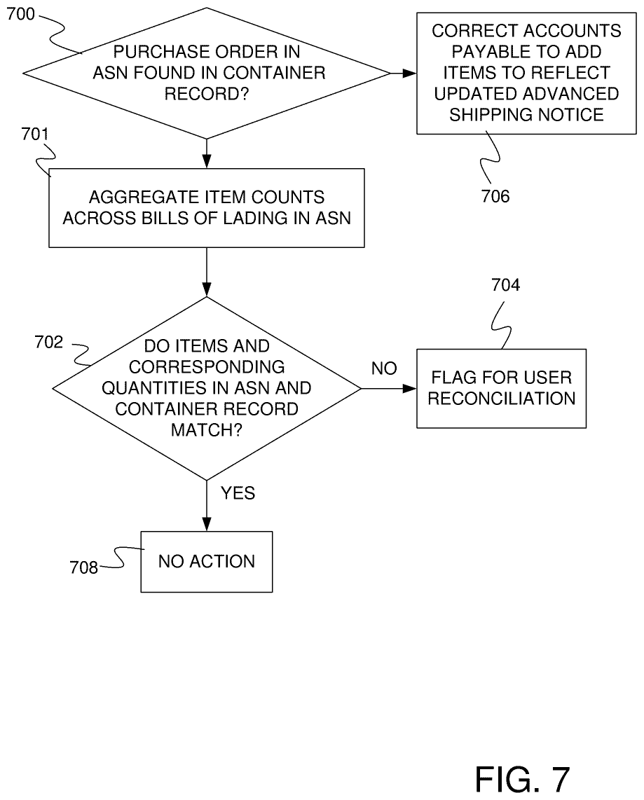

FIG. 7 provides a flow diagram of a method of processing advanced shipping notices that are considered to be updates of initial advanced shipping notices. The method of FIG. 7 improves a computing system by ignoring the information that is prone to error in the advanced shipping notice. In particular, the embodiment ignores bill of lading identifiers and instead groups item information regardless of the bill of lading that the items are said to be part of so as to avoid double counting items based on an erroneous advanced shipping notice.

In step 700 of FIG. 7, the container record in the database is checked to see if each purchase order listed in the advanced shipping notice is already present. If the purchase order is present, all items listed in the advanced shipping notice within the purchase order hierarchal level are grouped together regardless of the bill of ladings that they are asserted to be part of at step 701. Thus, for each item type, the total count across all bills of lading is determined. At step 702, first entity 112 compares the item types and number of each item type in the updated advanced shipping notice for each purchase order to the item types and number of each item type listed for the purchase order in the container record. If the counts match between the container record and the updated advanced shipping notice, no action is taken at step 708. If the aggregated item counts from the updated advanced shipping notice do not match the container record for the purchase order, an alert is sent to a user at step 706 to reconcile and determine how to handle the update.

When the purchase order in the updated advanced shipping notice is not present in the container record at step 700, the accounts payable are corrected to add items listed under the purchase order in the updated advanced shipping notice at step 706.

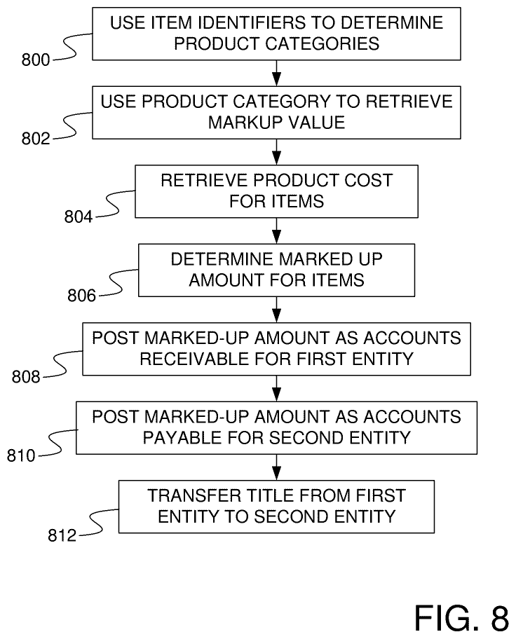

Returning to FIG. 2, when the vessel reaches a point that is two days from port at step 210, the first entity 112 determines a marked-up price for each of the items at step 212. FIG. 8 provides a flow diagram of one method used by first entity 112 to determine the marked-up price for an item.

In step 800, first entity 112 uses the item identifiers in the advanced shipping notice to determine a product category for each item identifier. This determination can be made by examining a database that associates each item identifier with a product category. At step 802, the product category is used to retrieve a markup value for the category where the markup value can be a percentage of the cost of the item or a fixed value. At step 804, the product cost for the identified item for first entity 112 is retrieved and the markup value is used with the product cost to determine a marked-up amount for the item at step 806. For example, the accounts payable amount can be multiplied by the percentage markup or the accounts payable amount can be added to a fixed markup value.

At step 808, the marked-up amount is posted in the accounting system as an accounts receivable for first entity 112 at step 808 and is posted as an account payable amount for second entity 122 at step 810. This is shown as a transfer of marked-up prices from first entity 112 to second entity 122 in FIG. 1. Title to the products is then transferred from first entity 112 to second entity 122 at step 812. This is shown as title transfer 120 in FIG. 1. In some embodiments, the bill of lading for the items is transferred from first entity 112 to second entity 122 as part of the transfer of title from first entity 112 to second entity 122.

Returning to FIG. 2, at step 216, the vessel reaches port and at step 218 a customs broker 128 (FIG. 1) pays the duty due on the items and provides a duty and broker invoice 126 to second entity 122.

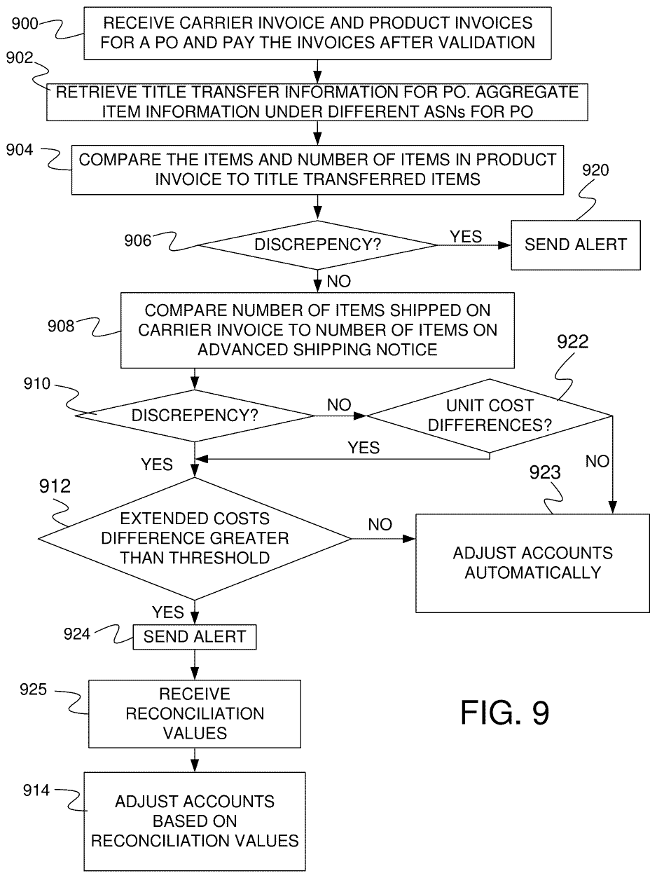

At step 220, the carrier offloads the product from the vessel and at step 222, the carrier invoices first entity 112 with a carrier invoice 124. At step 224, first entity 112 processes the carrier invoice. FIG. 9 provides a flow diagram of a method of processing the carrier invoice at step 224.

At step 900 of FIG. 9, first entity 122 receives carrier invoice 124 and product invoice 108 from carrier 110 and shipper 104. At step 902, first entity 112 retrieves details of advanced shipping notice information for a purchase order. The item details, including the number of items of each item type and the unit cost of the items provided in the advanced shipping notices are aggregated for the purchase order.

At step 904, the item types in the product invoice are compared to the item types that were title transferred based on advanced shipping notices while the items were in transit. If the item types are different at 906, an alert is sent to a user at step 920. If there is no discrepancy in the item types, the total quantity of items on the carrier invoice for the purchase order is compared to the total quantity of items that were title transferred based on advanced shipping notices at step 908. If there is no discrepancy in the number of items at step 910, the unit cost of each item type listed on the product invoice is compared to the corresponding unit cost on the advanced shipping notices at step 922. If there is no discrepancy in unit costs at step 922, no adjustment is needed as indicated by step 923.

If there is a discrepancy in unit costs at step 922 or a discrepancy in the total number of units at step 910, the extended costs for the shipment is calculated from the advanced shipping notices and from the product invoice and carrier invoices. The extended cost for the advanced shipping notice is the number of items listed in the advanced shipping notices times the unit costs of the items listed in the advanced shipping notice. The extended cost for the product invoice and carrier invoice is the number of items listed on the carrier invoice times the unit cost of the items on the product invoice. The difference between the extended cost for the shipping notices and the extended cost for the product invoices and carrier invoices is compared to a threshold at step 912. If the difference is less than the threshold, the accounts payable and accounts receivable for first entity 112 and second entity 122 are adjusted automatically. For example, the accounts are adjusted to reflect the number of items listed on the carrier invoice and the unit cost on the product invoices. no adjustment is needed as shown by step 923. If the difference is greater than the threshold, an alert is issued at step 924.

In response to the alert, a user selects the proper number of items and the proper unit cost that is to be used for this shipment at step 925. At step 914, these reconciliation values are used to adjust the accounts payable and accounts receivable for first entity 112 and second entity 122.

At step 916, the duty and broker fee in duty and broker invoice 126 is booked in the accounting system as accounts payable to second entity 122.

At step 918, the product is received by a third entity 102 and at step 920 the landed costs 130 are transferred from second entity 122 to third entity 103 in an accounting system. The landed costs include the product cost, freight costs, duty, broker fees, markup added by the first entity and an additional markup computed for the transfer from second entity 122 to third entity 102. The landed costs are transferred by marking the landed costs as an accounts receivable entry for second entity 122 and an accounts payable entry for third entity 102.

Title 132 is then transferred from second entity 122 to third entity 102 at step 922 for the identified items received at the third entity.

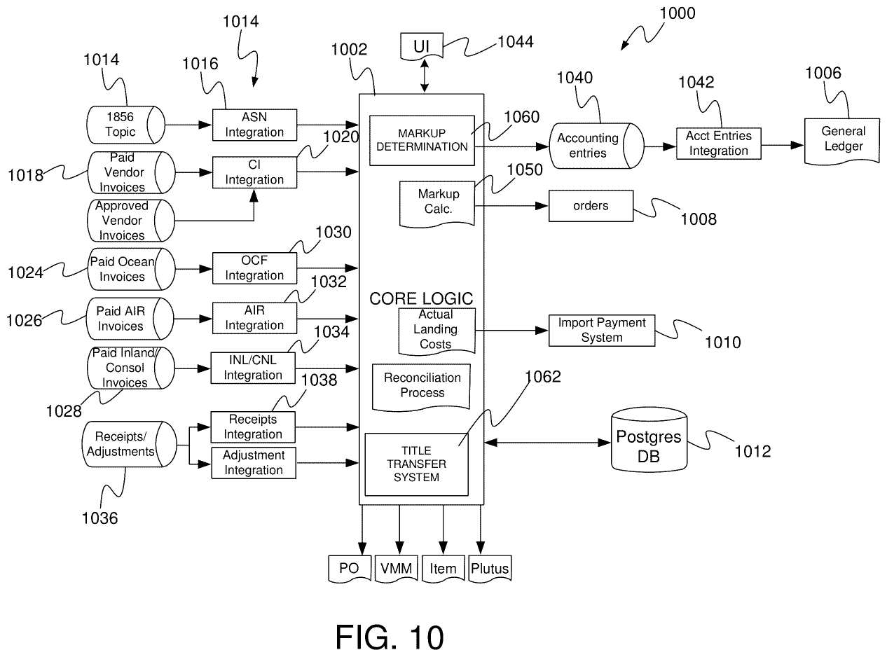

In the description above, first entity 112, second entity 122 and third entity 102 are each considered to perform separate functions. These functions can be performed by a single system 1000 shown in FIG. 10.

System 1000 includes core logic 1002, which receives input documents through integration systems 1004 and updates various external systems, such as accounting system 1006, purchase order system 1008, supply chain finance application 1010 and database 1012. Integration systems 1004 include ASN integration 1016, commercial invoice integration 1020, OCF integration 1030, AIR integration 1032, INL/CNL integration 1034 and receipts integration 1038. Core logic 1002 includes a markup determination system 1060 for performing the steps of FIG. 8 for determining markups of products and a title transfer system 1062 for transferring title between entities.

Advanced shipping notices 1014 are received by ASN integration 1016 where they are stored until Core Logic 1002 can process an advanced shipping notice. Product invoices 1018 are received by commercial invoice integration 1020 where they are stored until they can be processed by Core Logic 1002. Carrier invoices, such as ocean invoices 1024, air invoices 1026 and inland invoices 1028 are received by respective integration systems 1030, 1032 and 1034. Receipts 1036 representing what was actually received, are received by receipts integration 1038 and held until Core Logic 1002 can process the receipts.

Core Logic 1002 contains the markup values 1050 for the categories used in the method of FIG. 8 to mark up the prices of items. Markup values 1050 can be accessed by purchase order system 1008 so that core logic 1002 becomes the source of truth for markup values. In accordance with one embodiment, markup values 1050 are proved to core logic 1002 by a user through one or more user interfaces 1044.

Accounts payable entries and accounts receivable entries described above are provided by Core Logic 1002 as accounting entries 1040 to an accountings integration system 1042 which uploads the entries into accounting system 1006. In addition, title transfers can be provided as accounting entries 1040.

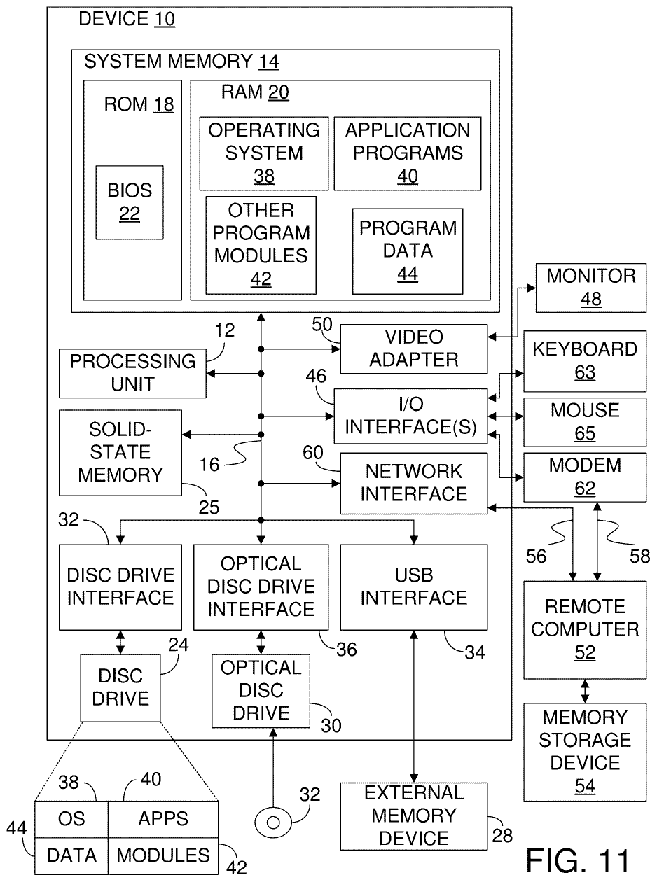

FIG. 11 is a block diagram of a computing device 10 that can be used to implement one or more of core logic 1002, accounting system 1006, purchase order system 1008, and supply chain finance application 1010. Computing device 10 includes a processing unit 12, a system memory 14 and a system bus 16 that couples the system memory 14 to the processing unit 12. System memory 14 includes read only memory (ROM) 18 and random-access memory (RAM) 20. A basic input/output system 22 (BIOS), containing the basic routines that help to transfer information between elements within the computing device 10, is stored in ROM 18. Computer-executable instructions that are to be executed by processing unit 12 may be stored in random access memory 20 before being executed.

Computing device 10 further includes an optional hard disc drive 24, an optional external memory device 28, and an optional optical disc drive 30. External memory device 28 can include an external disc drive or solid-state memory that may be attached to computing device 10 through an interface such as Universal Serial Bus interface 34, which is connected to system bus 16. Optical disc drive 30 can illustratively be utilized for reading data from (or writing data to) optical media, such as a CD-ROM disc 32. Hard disc drive 24 and optical disc drive 30 are connected to the system bus 16 by a hard disc drive interface 32 and an optical disc drive interface 36, respectively. The drives and external memory devices and their associated computer-readable media provide nonvolatile storage media for the computing device 10 on which computer-executable instructions and computer-readable data structures may be stored. Other types of media that are readable by a computer may also be used in the exemplary operation environment.

A number of program modules may be stored in the drives and RAM 20, including an operating system 38, one or more application programs 40, other program modules 42 and program data 44. In particular, application programs 40 can include programs for implementing any one of the applications discussed above. Program data 44 may include any data used by the systems and methods discussed above.

Processing unit 12, also referred to as a processor, executes programs in system memory 14 and solid-state memory 25 to perform the methods described above.

Input devices including a keyboard 63 and a mouse 65 are optionally connected to system bus 16 through an Input/Output interface 46 that is coupled to system bus 16. Monitor or display 48 is connected to the system bus 16 through a video adapter 50 and provides graphical images to users. Other peripheral output devices (e.g., speakers or printers) could also be included but have not been illustrated. In accordance with some embodiments, monitor 48 comprises a touch screen that both displays input and provides locations on the screen where the user is contacting the screen.

The computing device 10 may operate in a network environment utilizing connections to one or more remote computers, such as a remote computer 52. The remote computer 52 may be a server, a router, a peer device, or other common network node. Remote computer 52 may include many or all of the features and elements described in relation to computing device 10, although only a memory storage device 54 has been illustrated in FIG. 11. The network connections depicted in FIG. 11 include a local area network (LAN) 56 and a wide area network (WAN) 58. Such network environments are commonplace in the art.

The computing device 10 is connected to the LAN 56 through a network interface 60. The computing device 10 is also connected to WAN 58 and includes a modem 62 for establishing communications over the WAN 58. The modem 62, which may be internal or external, is connected to the system bus 16 via the I/O interface 46.

In a networked environment, program modules depicted relative to the computing device 10, or portions thereof, may be stored in the remote memory storage device 54. For example, application programs may be stored utilizing memory storage device 54. In addition, data associated with an application program may illustratively be stored within memory storage device 54. It will be appreciated that the network connections shown in FIG. 11 are exemplary and other means for establishing a communications link between the computers, such as a wireless interface communications link, may be used.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms for implementing the claims.

1. A method comprising:
receiving an advanced shipping notice from a shipper;
parsing a shipping date from the advanced shipping notice;
comparing the shipping date to an arrival date stored in an entry for a container; and
treating the advanced shipping notice as an updated advanced shipping notice instead of an original advanced shipping notice when the shipping date is before the arrival date or less than a selected number of days after the arrival date.

2. The method of claim 1 wherein a previous advanced shipping notice includes at least one bill of lading identifier that is different from a bill of lading identifier in the received advanced shipping notice.

3. The method of claim 2 further comprising:
comparing all items in an updated advanced shipping notice that are designated for a purchase order to items listed in an original advanced shipping notice for the purchase order to determine whether the items in the updated advance shipping notice match the items listed in the original advanced shipping notice.

4. The method of claim 3 further comprising:
when the items for the purchase order in the updated advanced shipping notice do not match the items for the purchase order in the original advanced shipping notice, sending an alert to a user to reconcile the updated advanced shipping notice with the original advanced shipping notice.

5. The method of claim 1 further comprising treating the received advanced shipping notice as an original advanced shipping notice when the shipping date is more than the selected number of days after the arrival date.

6. The method of claim 5 wherein treating the received advanced shipping notice as an original advanced shipping notice comprises scheduling a date for transferring title of an item in the received advanced shipping notice based on a date in the received advanced shipping notice.

7. The method of claim 6 further comprising on the date for transferring title posting an accounting entry for the item that includes a markup.

8. A system comprising:
an advanced shipping notice receiving system that receives advanced shipping notices;
an advance shipping notice logic system that performs steps comprising:
comparing a shipping date for a container in a received advance shipping notice to an arrival date in an existing record for the container;
when the shipping date is after the arrival date by a selected number of days, processing the advanced shipping notice as an initial advanced shipping notice for a shipment; and
when the shipping date is before the arrival date or less than the selected number of days after the arrival date, processing the advanced shipping notice as an update to an initial advanced shipping notice.

9. The system of claim 8 wherein processing the advanced shipping notice as the initial advanced shipping notice comprises using a date in the advanced shipping notice to set a date when title to an item in the advanced shipping notice is to be transferred from a first entity to a second entity.

10. The system of claim 9 wherein processing the advanced shipping notice as the initial advanced shipping notice comprises storing item information for a purchase order in the advanced shipping notice in the existing record for the container.

11. The system of claim 8 further comprising:
a markup determination system performing steps comprising:
retrieving an item identifier provided in an advanced shipping notice;
using the item identifier to determine a category of items;
using the category of items to retrieve a markup value; and
using the markup value to determine a markup for an item identified in the advanced shipping notice.

12. The system of claim 8 wherein processing the advanced shipping notice as an update to the initial advanced shipping notice comprises:
aggregating items in the advanced shipping notice that are associated with different bills of lading but a same purchase order to form aggregated items;
comparing the aggregated items for a purchase order to items for the purchase order in the existing record for the container.

13. The system of claim 12 wherein processing the advanced shipping notice as an update to the initial advanced shipping notice further comprises:
when the aggregated items for the purchase order do not match the items for the purchase order in the existing record for the container, sending an alert to a user.

14. The system of claim 9 further comprising:
a title transfer system performing steps comprising:
on the set date, transferring title to the item in the advanced shipping notice from the first entity to the second entity; and
after items are unloaded from a vessel and reached a location of a third entity, transferring title to the item from the second entity to a third entity.

15-20. (canceled)

21. A system comprising:
an advanced shipping notice receiving system that receives advanced shipping notices;
an advance shipping notice logic system that performs steps to avoid data corruption comprising:
a processor parsing a shipping date for a container in a received advance shipping notice;
the processor reading an arrival date in an existing stored record for the container;
the processor selecting between processing the advanced shipping notice as an initial advanced shipping notice for a shipment and processing the advanced shipping notice as an update to an initial advanced shipping notice based on the shipping date for the container and the arrival date for the container so as to avoid data corruption of the stored record.

22. The system of claim 21 wherein processing the advanced shipping notice as the initial advanced shipping notice comprises using a date in the advanced shipping notice to set a date when title to an item in the advanced shipping notice is to be transferred from a first entity to a second entity.

23. The system of claim 22 wherein processing the advanced shipping notice as the initial advanced shipping notice comprises storing item information for a purchase order in the advanced shipping notice in the existing record for the container.

24. The system of claim 21 further comprising:
a markup determination system performing steps comprising:
a processor retrieving an item identifier provided in an advanced shipping notice;
the processor using the item identifier to determine a category of items;
the processor using the category of items to retrieve a markup value; and
the processor using the markup value to determine a markup for an item identified in the advanced shipping notice.

25. The system of claim 21 wherein processing the advanced shipping notice as an update to the initial advanced shipping notice comprises:
aggregating items in the advanced shipping notice that are associated with different bills of lading but a same purchase order to form aggregated items;
comparing the aggregated items for a purchase order to items for the purchase order in the existing record for the container.

26. The system of claim 25 wherein processing the advanced shipping notice as an update to the initial advanced shipping notice further comprises:
when the aggregated items for the purchase order do not match the items for the purchase order in the existing record for the container, sending an alert to a user.
